(19) United States
(12) Patent Application Publication
(10) Pub. No.: US 2013/0248561 A1
(43) Pub. Date: Sep. 26, 2013

(54) ROTARY DEVICE FOR THE STORAGE AND DISTRIBUTION OF LIQUID PRODUCTS, SUCH AS BASE COLOURS FOR AUTOMOTIVE PAINT

(71) Applicants: Aurelien Brule, Chartres (FR); Anthony Valot, Saint Laurent La Gatine (FR)

(72) Inventors: Aurelien Brule, Chartres (FR); Anthony Valot, Saint Laurent La Gatine (FR)

(73) Assignee: Fillon Technologies, Faverolles (FR)

(21) Appl. No.: 13/991,675

(22) PCT Filed: Dec. 14, 2011
(86) PCT No.: PCT/FR11/52995

§ 371 Date: Jun. 5, 2013

(30) Foreign Application Priority Data
Dec. 14, 2010 (FR) 1060479

(51) Int. Cl. B05B 15/02

(52) U.S. Cl. CPC B05B 15/0208
USPC 222/148; 222/144

(57) ABSTRACT

This device includes metering valves (31, 32, 33)arranged in at least one circumferential row in such a manner that the valves of a circumferential row follow a circular path (TC1, TC2, TC3) during rotation of the dispenser device. It further includes a cleaner system for cleaning the valves and including at least one stationary dry brush (41, 42, 51, 52, 60) that is arranged on at least one circular path (TC1, TC2, TC3) in such a manner as to come into rubbing contact against the valves of at least one circumferential row of valves.

The invention relates to a rotary device for storing and dispensing liquids.

A particularly advantageous application of the invention lies in the field of storing, selecting, and metering out base tints for paint, in particular for paints that are prepared on request by car repair professionals.

In this field, body shops prepare the quantities of paint needed for repairing bodywork by mixing a certain number of base tints. Each mixture is determined from a formula defined by the paint manufacturer, the formula giving the weight of each base tint to be incorporated in a given quantity of mixture that is to be obtained. Such preparation commonly involves mixing five to six base tints together in order to obtain the particular shade specified by the paint manufacturer.

In order to perform those operations, document WO 2009/153504 A1 (Fillon Technologies) discloses a rotary liquid dispenser device having a plurality of containers storing different respective base tints. By way of example, a container may be constituted by a cell defining a closed inside volume suitable for housing in sealed manner a deformable pouch containing one of the base tints.

Each pouch is provided with a metering valve that enables the corresponding base tint to be expelled into a collector container of the device when the inside volume of the cell is put under pressure.

The containers are secured in a circumferential configuration to a carousel having a horizontal axis of rotation. The carousel is indexed in rotation so that the metering valve of a selected container is brought, in a dispensing position, into register with the collector container. Metering means then cause a predetermined quantity of the tint to be expelled into the collector container.

The metering valves are arranged along the carousel in one or more parallel circumferential rows, with the valves in each row describing a circular path when the carousel of the dispenser device is set into rotation.

A metering valve has a duct that is terminated by an endpiece, generally in the form of a spherical tip, which endpiece is pierced by a through hole communicating with the inside of the deformable pouch so as to enable the base tint contained in the pouch to be expelled towards the collector container.

The through hole may be opened or closed at will by means of a shutter coupled to an electromagnetic coil placed around the valve duct and suitable for causing the shutter to move in translation parallel to the duct under the action of the above-mentioned metering means.

In practice, after dispensing, it is found that traces of paint may remain on the spherical tip of the valve in the vicinity of the through hole and the shutter. On drying, this dirtying runs the risk of clogging the through hole and thus of giving rise to problems of metering associated with a valve having its through hole blocked in full or in part.

This is in addition to paint projections coming from splashing at the time the quantity of paint is ejected into the collector container, where such projections can also dirty the valve. In particular, such projections are likely to give rise to operating problems for the machine by coating the valve duct in register with the coil which can lead to the valve sticking or even being torn off.

In order to remedy those difficulties, rotary liquid dispenser devices are generally provided with so-called “wet” cleaner means that involve washing the ducts and the spherical valve tips by means of movable brushes or sponges that have a system for moistening them with solvent, which may be water, so as to dilute the remaining paint and make cleaning easier.

Nevertheless, that known cleaning system presents a certain number of drawbacks. It is necessary to remember to refill the solvent tank, particularly given that account needs to be taken of a tendency to evaporate. There are also risks of solvent running, and thus polluting the various members of the dispenser device. Finally, the valves are cleaned only intermittently, without there being any possibility of responding quickly to dirt forming or to valves leaking.

Thus, one of the objects of the invention is to provide a rotary liquid dispenser device that makes it possible firstly to avoid the above-mentioned drawbacks relating to “wet” cleaning, and secondly to be able to get rid of residues or projections of paint immediately whenever they form on the valves.

According to the invention, this object is achieved by a rotary liquid dispenser device having metering valves arranged in at least one circumferential row in such a manner that the valves of a circumferential row follow a circular path during rotation of the dispenser device, the device being remarkable in that it further includes a cleaner system for cleaning the valves and comprising at least one dry brush that is stationary during cleaning and that is arranged on at least one circular path in such a manner as to come into rubbing contact against the valves of at least one circumferential row of valves.

Thus, it can be understood that the cleaner system of the invention makes use of one or more so-called “dry” brushes, i.e. brushes that clean the valves merely by the bristles of the brush rubbing against the valves, without any additional solvent.

Furthermore, during cleaning, the or each dry brush is stationary as contrasted with the rotary elements such as the valves of the carousel that is performing rotary motion, the brush then being secured to a stationary structure of the dispenser device. That configuration presents the advantage of ensuring that the valves are cleaned continuously as a result of the carousel of the device being driven continuously in rotation, during which rotation the valves necessarily come into contact with the cleaner brush(es).

As described in above-mentioned WO 2009/153504 A1, rotation may take place when indexing means cause the carousel to turn so as to bring the selected containers into a dispensing position. When not indexing containers, the carousel may for example be set into rotation continuously or periodically in order to produce a rotating gravity field suitable for preventing particles present in suspension in the base tints of the containers from settling in the pouches in the containers.

The brushes may optionally be retracted outside periods of cleaning, when the device is not in use, in particular in order to reduce wear on the spherical tips of the valves once they have been cleaned. Retraction may be triggered automatically after a given period of time (e.g. one hour) or after a predetermined number of revolutions of the carousel since the most recent use of the device.

In a first embodiment, the cleaner system comprises at least one brush arranged on a circular valve path. In other words, each circumferential row has one or more brushes specific thereto.

In a second embodiment, the cleaner system comprises at least one brush arranged on a plurality of circular valve paths. Under such circumstances, a plurality of circumferential rows share one or more of the same brushes.

Advantageously, said brush is configured to present a varying penetration depth for the valves in the brush. This achieves progressive cleaning of the valves, e.g. beginning by coarse cleaning during which the valve penetrates deeply into the brush and terminating with finer cleaning of the spherical tips of the valves moving flush with the ends of the brush bristles.

The invention also provides for said brush to be placed at the outlet from a liquid dispenser station of the dispenser device, i.e. close to and downstream from the dispenser station relative to the direction of rotation of the carousel, with this being done so that the selected valve can be cleaned as soon as possible after expelling paint and before the paint has had time to dry or run along the spherical tip.

For the same purpose, the device in accordance with the invention has two brushes placed on respective sides of the liquid dispenser station of the dispenser device. This arrangement is particularly advantageous when the dispenser device includes means for reversing its direction of rotation, since early cleaning of a valve can be obtained at the outlet from the dispenser station regardless of the direction of rotation of the carousel. In addition, it is possible to provide symmetrical cleaning of the spherical tips of the valves by reversing the direction of rotation.

Finally, in a particular embodiment of the invention, a dust collector bin is situated under the brush, in order to collect the dust raised by the bristles rubbing against the valves, and in order to prevent the dust from dispersing and possibly polluting or interfering with the operation of certain sensitive members of the dispenser device.

An advantage of the cleaner system proposed by the invention is its ease of design and manufacture, which leads to low cost.

Another advantage is that it requires only very limited maintenance, since there is no supply of solvent to be refilled nor is there any wiper system to be kept wet and clean.

There follows a description of an embodiment of a device of the invention given with reference to the accompanying drawings, in which the same numerical references are used from one figure to another to designate elements that are identical or functionally similar.

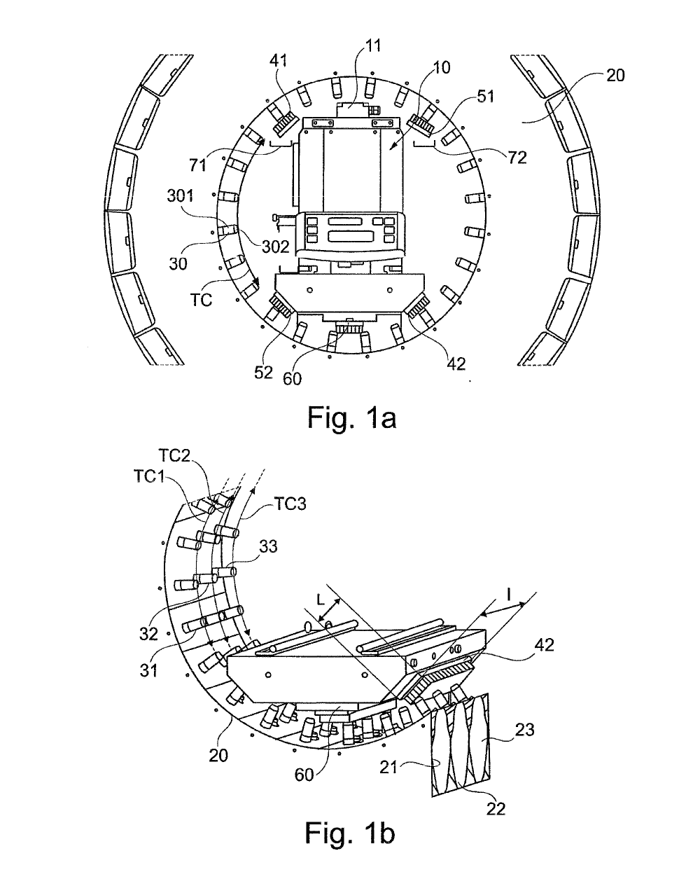

FIG. 1a is a face view of a rotary liquid dispenser device in accordance with the invention.

FIG. 1b is a perspective view of the FIG. 1a device.

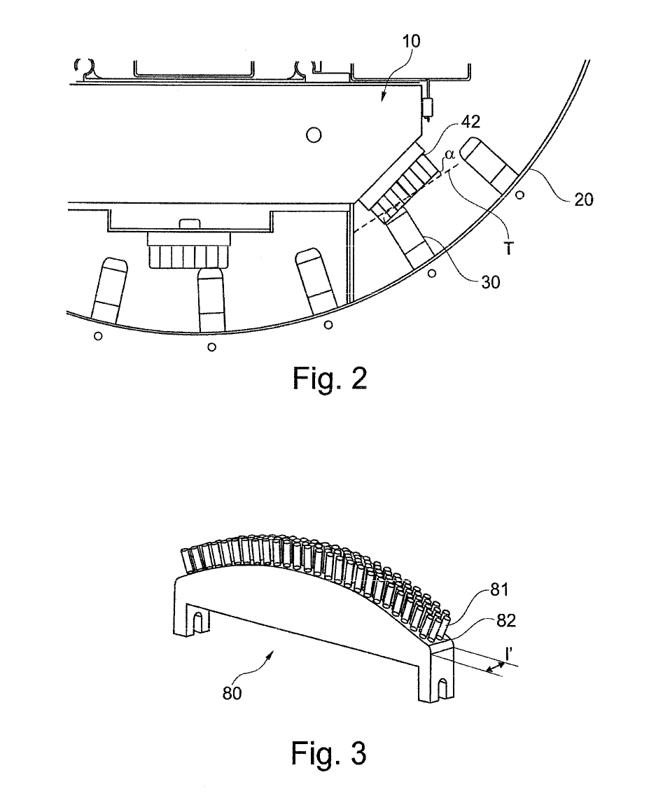

FIG. 2 is a detail view of the FIG. 1a device.

FIG. 3 is a perspective view of a curved brush for fitting to the device of FIGS. 1a and 1b.

FIGS. 1a and 1b show a rotary liquid dispenser device, in particular for dispensing base tints for painting, and of the type described in above-mentioned WO 2009/153504 A1.

The device is built around a stationary structure 10 including in particular a dispenser station 11 having a collector container (not shown) that serves to collect the base tints for the paint that is to be made. These base tints are contained in deformable pouches 21, 22, and 23 from which they can be expelled through metering valves 31, 32, and 33 as shown in FIG. 1b, which valves are given overall reference 30 in FIGS. 1a and 2.

The deformable pouches 21, 22, and 23 and the metering valves 31, 32, and 33 of FIGS. 1a, 1b, and 2 are mounted in three circumferentially-parallel rows on a carousel that is rotatable about the stationary structure 10. Naturally, there could be any number of circumferential rows.

Given the color of the paint that is to be reproduced, a certain number of deformable pouches are selected automatically by the dispenser device as prescribed by paint manufacturers. Indexer means then bring the pouches that are selected in this way in succession into register with the dispenser station 11. Metering means then cause a predetermined quantity of tint to be expelled into the collector container of the dispenser station 11.

In the rotary motion that is imparted thereto by the carousel 20, the valves in each circumferential row follow respective circular paths referenced TC1, TC2, and TC3 in FIG. 1b, and given overall reference TC in FIG. 1a.

In order to solve the above-mentioned problems associated with cleaning the metering valves 31, 32, and 33, the rotary dispenser device shown in FIGS. 1a, 1b, and 2 is fitted with a cleaner system comprising, in general terms: at least one dry brush fastened to the stationary structure 10 of the device and arranged on at least one of the circular paths so as to come into rubbing contact with the valves of at least one circumferential row of valves.

In the particular embodiment shown in the above-specified figures, the cleaner system has five brushes, namely: the brush 41 that corresponds to the brush 42 by rotation through 180°; the brush 51 that corresponds to the brush 52, likewise by rotation through 180°; and a central brush 60.

These brushes are used without adding any solvent, which is why they are said to be “dry”. The duct 301 and the spherical tip 302 of each valve are cleaned solely by rubbing against the bristles of the brushes. In order to limit the abrasive effect on the valves, the bristles are preferably made of nylon.

Furthermore, the brushes are stationary in the sense that since they are fastened to the structure 10, their positions are independent of the rotation of the carousel 20. Rubbing between the valves and the brushes results from relative rotary movement between them.

It may be observed that in the embodiment of FIGS. 1a, 1b, and 2, the brushes 41, 42, 51, 52, and 60 are plane and are arranged transversely across all of the circular paths TC1, TC2, TC3. In other words, the valves of the three circumferential rows share the five brushes in common. Under such circumstances, the width l of the brushes 41, 42, 51, 52, and 60 is not less than the distance between the extreme circumferential rows of valves, whereas their length L is determined so as to ensure that cleaning is sufficient, and can involve only one valve at a time from each of the circumferential rows, as can be seen in FIGS. 1a, 1b, and 2.

Other variants may be envisaged compared with the configuration shown in these figures.

Thus, as can be seen in FIG. 3, the brushes may be curved so as to be generally in the form of circular arcs with a radius of curvature close to that of the circular paths TC1, TC2, and TC3. In the example described, the angular extent of a brush is about 50°.

Furthermore, this same figure shows a brush 80 for placing on a single circumferential row of valves. This brush thus has a width l′ that is not less than the diameter of the valves. Its bristles 81 are implanted in holes 82 in a staggered three-row arrangement, the holes in any one row being angularly spaced apart by 2°, thereby giving a total number of holes of about 125. The number of bristles per hole may lie in the range 150 to 200. With this type of brush, a plurality of valves in a given row are cleaned simultaneously by the same brush.

As shown more particularly in FIG. 1a, the brushes 41 and 51 are placed on respective sides of the base tint dispenser station 11. This configuration corresponds to a dispenser device fitted with means for reversing the direction of rotation of the carousel 20. Whatever the direction of rotation, one of the brushes 41 or 51 lies immediately after the exit from the dispenser station 11, thus ensuring that the valves are cleaned quickly after they have expelled tint. When not in a dispensing situation, continuous rotation of the carousel prevents tints from settling in the pouches, and periodically reversing the direction of rotation makes it possible for valve cleaning to be made symmetrical and thus for the entire surface of the spherical tip of each valve to be cleaned.

If there is no reversal in the direction of rotation, then one of the brushes 41 or 51 may be omitted, possibly together with the diametrically opposite brush 42 or 52.

Under the top brushes 41 and 51, FIG. 1a shows the presence of two bins 71 and 72 for recovering and removing dust that is produced by the bristles of the brushes rubbing against the valves.

It may be advantageous to ensure that the valves penetrate to varying depths in the bristles of the brushes, e.g. by allowing the valves initially to penetrate to a depth of several millimeters so as to be cleaned coarsely, after which they are wiped almost flush over a depth that is very small in order to maximize cleaning of the spherical tips of the valves.

For this purpose, and as shown in FIG. 2, it is possible for the brushes to be at a slope relative to the tangent T of the corresponding circular path of a valve 30, as is shown for the plane brush 42. This slope is represented by the angle α in FIG. 2. The same arrangement may be applied to the curved brushes.

1. A rotary device for storing and dispensing liquids, in particular base tints for painting cars, the device having metering valves (31, 32, 33) arranged in at least one circumferential row in such a manner that the valves of a circumferential row follow a circular path (TC1, TC2, TC3) during rotation of the dispenser device, the device being characterized in that it further includes a cleaner system for cleaning the valves and comprising at least one dry brush (41, 42, 51, 52, 60) that is stationary during cleaning and that is arranged on at least one circular path (TC1, TC2, TC3) in such a manner as to come into rubbing contact against the valves of at least one circumferential row of valves.

2. A device according to claim 1, wherein the cleaner system comprises at least one brush (80) arranged on a circular valve path.

3. A device according to claim 1, wherein the cleaner system comprises at least one brush (41, 42, 51, 52, 60) arranged on a plurality of circular valve paths (TC1, TC2, TC3).

4. A device according to claim 1, wherein said brush (80) is curved.

5. A device according to claim 1, wherein said brush (41, 42, 51, 52, 60) is plane.

6. A device according to claim 4, wherein said brush is configured to present a varying penetration depth for the valves (31, 32, 33) in the brush.

7. A device according to claim 1, wherein said brush (41, 51) is placed at the outlet from a liquid dispenser station (11) of the dispenser device.

8. A device according to claim 1, having a dust collector bin (71, 72) that is under the brush (41, 42).

9. A device according to claim 7, further including a second brush located substantially 180° from said brush on the circular path.

10. A device according to claim 7, having two brushes (41, 51) placed on respective sides of the station (11) for dispensing liquids from the device.

11. A device according to claim 1, including means for reversing its direction of rotation.

12. A device according to claim 1, wherein the brush is made of nylon bristles.

13. A device according to claim 1, wherein the brush is made of bristles arranged in a staggered configuration.

14. A device according to claim 1, wherein the brush is a brush that is retractable outside periods of cleaning and when the device is not in use.

15. A device according to claim 14, including means for causing the brush to be retracted automatically after a given period of time or a predetermined number of revolutions after the most recent use of the device.

16. A device according to claim 5, wherein said brush is configured to present a varying penetration depth for the valves (31, 32, 33) in the brush.

17. A device according to claim 8, further including a second brush located substantially 180° from said brush on the circular path.

18. A device according to claim 8, having two brushes (41, 51) placed on respective sides of the station (11) for dispensing liquids from the device.

19. A device according to claim 9, having two brushes (41, 51) placed on respective sides of the station (11) for dispensing liquids from the device.
